(19) United States
(12) Patent Application Publication
(10) Pub. No.: US 2007/0222720 A1
(43) Pub. Date: Sep. 27, 2007

(54) Display device and method of driving the same

(75) Inventor: Ji Hun Kim, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/633,495

(22) Filed: Dec. 5, 2006

(30) Foreign Application Priority Data
Mar. 24, 2006 (KR) 10-2006-0026971

(51) Int. Cl. G09G 3/32

(52) U.S. Cl. 345/82

(57) ABSTRACT

The present invention relates to a display device. The display device comprising: a plurality of pixels formed in cross areas of data lines and scan lines; and a driver for providing data current to at least one pixel. Here, the driver includes a controller for providing second display data of N+M bit in accordance with first display data of N bit; a reference current circuit for generating reference currents; a mode selecting circuit for selecting one of the reference currents as bias current in accordance with the second display data provided from the controller; a current generating circuit for generating current corresponding to the second display data using the reference current selected by the mode selecting circuit; and a sub-data driving circuit having mirror circuit, and provide data current proportional to the current generated from the current generating circuit using the mirror circuit.

### CROSS-REFERENCE TO RELATED APPLICATIONS

This application claims priority from Korean Patent Application No. 2006-26971, filed on Mar. 24, 2006, the contents of which are incorporated herein by reference in its entirety.

### BACKGROUND OF THE INVENTION

1. Field of the Invention

The present invention relates to a display device and a method of driving the same. More particularly, the present invention relates to a display device for compensating gamma by using a mode selecting way and a method of driving the same.

2. Description of the Related Art

A display device displays a certain image, and is employed in various apparatuses such as camcorder, etc.

FIG. 1A is a block diagram illustrating an apparatus employing a common display device. FIG. 1B to FIG. 1D are views illustrating brightness change in accordance with the change of gamma. FIG. 2 is a view illustrating the display device in FIG. 1A.

In FIG. 1A, an apparatus such as camcorder, etc includes a converting circuit 100 and a display device 102.

The converting circuit 100 receives an input data, and converting the received input data into first display data through first gamma compensation. Here, gamma (γ) is an index indicating the characteristics of brightness change of the converting circuit 100 as shown in FIG. 1B. That is, the change rate of gray scale corresponding to the input data and gray scale corresponding to the first display data is yγ, wherein γ is positive real number.

Generally, the brightness of the converting circuit 100 has non-linear characteristics as shown in FIG. 1B. Accordingly, the display device 102 uses a second gamma capable of compensating a first gamma of the converting circuit 100. For example, the display device 102 uses the second gamma as shown in FIG. 1C. As a result, the apparatus such as camcorder, etc displays finally an image having the characteristics of brightness as shown in FIG. 1D. In other words, in case that outside image is taken by a camcorder, a display device included in the camcorder displays the taken outside image with linear-characteristics through the above gamma compensation.

For this gamma compensation, the display device 102 employs a circuit as shown in FIG. 2.

In FIG. 2, the display device 102 includes a look-up circuit 200, a reference current circuit 202, a current generating circuit 204, a time adjusting circuit 206 and a mirror circuit 208.

The look-up circuit 200 receives first display data, selects second display data corresponding to the received first display data from a look-up table, and provides the selected second display data to the current generating circuit 204. Here, for example, the first display data has 6 bits [5, 0], and the second display data has 7 bits [k0 to k6].

The reference current circuit 202 has one current source and a MOS transistor M0.

The current source generates reference current Iref.

The current generating circuit 204 includes a plurality of MOS transistors M1 to M7 and switches SW1 to SW7 connected respectively to the MOS transistors M1 to M7. Here, the switches SW1 to SW7 are switched in accordance with the second display data provided from the look-up circuit 200.

For instance, when the second display data is 1, 0, 0, 1, 0, 0 and 0, the switches SW4 and SW7 are turned on, and the other switches SW1, SW2, SW3, SW5 and SW6 are turned off Consequently, current corresponding to sum of current passing through the switch SW7, i.e. current passing through MOS transistor M7 and current passing through the switch SW4, i.e. current passing through MOS transistor M4 is generated from the current generating circuit 204. Here, since MOS transistor M0 included in the reference current circuit 202 and the MOS transistors M1 to M7 form mirror structure, current passing through MOS transistor M1 is 1×Iref, current passing through MOS transistor M2 is 2×Iref, and current passing through MOS transistor M3 is 4×Iref. In addition, current passing through MOS transistor M4 is 8×Iref, current passing through MOS transistor M5 is 16×Iref, and current passing through MOS transistor M6 is 32×Iref Moreover, current passing through MOS transistor M7 is 64×Iref

The time adjusting circuit 206 is made up of MOS transistor, and is turned on during a predetermined period of time.

The mirror circuit 208 has MOS transistor having mirror structure. Accordingly, data current I proportional to current generated from the current generating circuit 204 is provided to a pixel E through data line during a time that the time adjusting circuit 206 is turned on.

FIG. 2 shows only one pixel corresponding to one data line. However, in fact, the display device 102 has a plurality of data lines, and so includes a plurality of pixels corresponding to the data lines. That is, circuits having the same constitution as circuit shown in FIG. 2 are connected to the data lines, respectively.

In brief, the display device 102 generates the second display data having 7 bits when the first display data of 6 bits are inputted to the look-up circuit 200 so that gamma characteristics as shown in FIG. 1C is embodied in the display device 102. In other words, the display device 102 adds 6 bits (first display data) to 1 bit so that the display device 102 has gamma characteristics as shown in FIG. 1C.

In view of circuit, the MOS transistor M7 corresponding to 1 bit is added to the current generating circuit 204. In this case, the MOS transistor M7 has magnitude similar to sum of magnitude of each of MOS transistors M1 to M6, and thus thickness of the current generating circuit 204 is increased. Accordingly, the thickness of the display device 102 is also increased.

### BRIEF DESCRIPTION OF THE DRAWINGS

The above and other features and advantages of the present invention will become readily apparent by reference to the following detailed description when considered in conjunction with the accompanying drawings wherein:

FIG. 1A is a block diagram illustrating an apparatus employing a common display device;

FIG. 1B to FIG. 1D are views illustrating brightness change in accordance with the change of gamma;

FIG. 2 is a view illustrating the constituent of the display device in FIG. 1A;

FIG. 3 is a view illustrating a display device according to one embodiment of the present invention;

FIG. 4 is a view illustrating circuitry of the display device in FIG. 3 according to one embodiment of the present invention; and

FIG. 5A and FIG. 5B are views illustrating brightness change of the display device in accordance with change of gamma.

### DESCRIPTION OF EMBODIMENTS

Hereinafter, the preferred embodiments of the present invention will be explained in more detail with reference to the accompanying drawings.

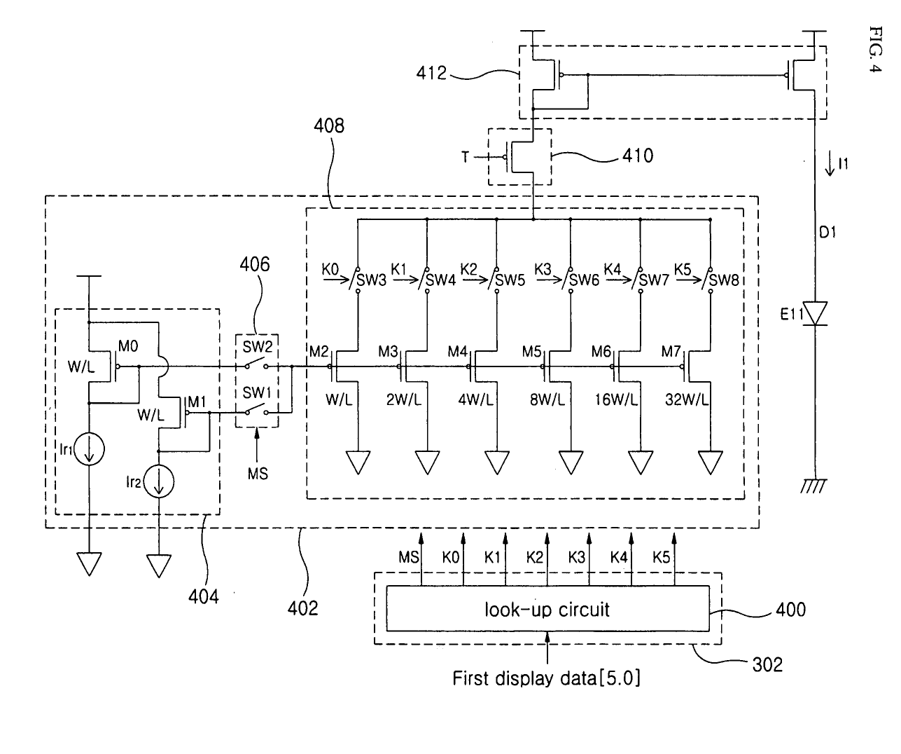

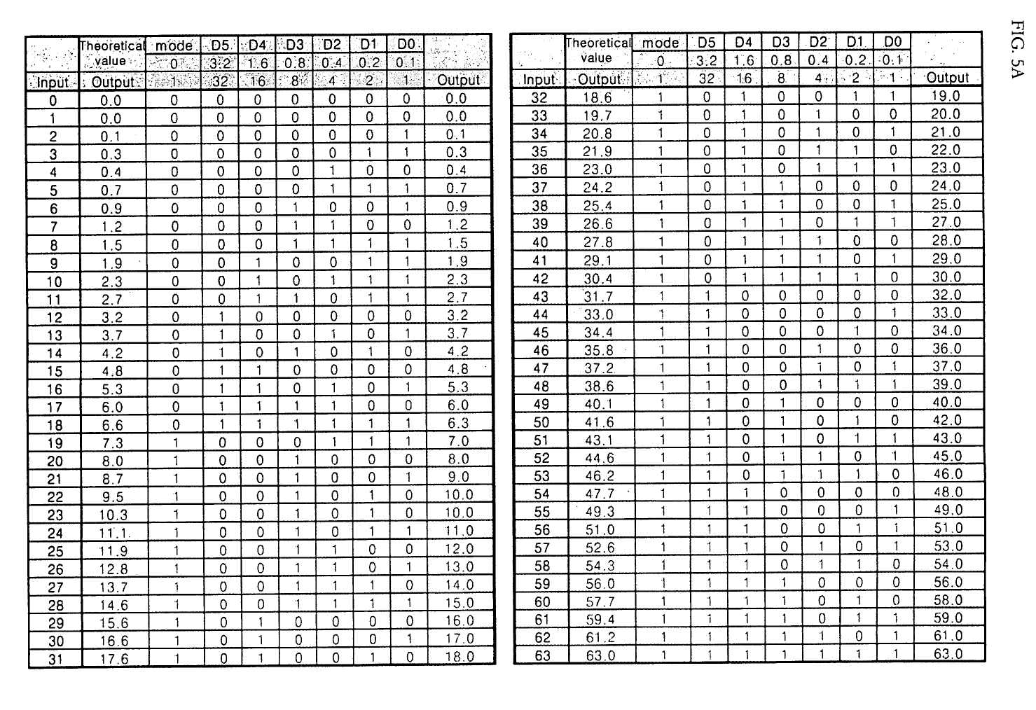

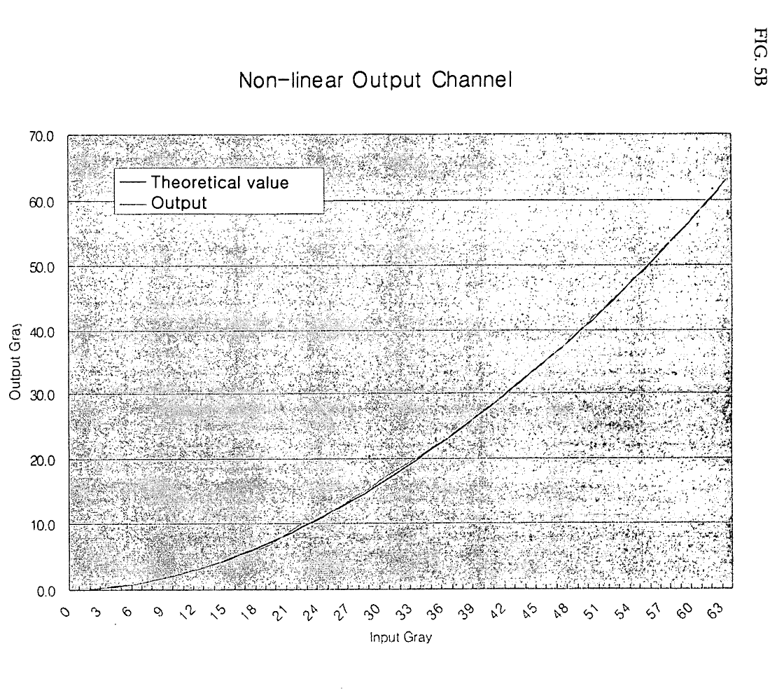

FIG. 3 is a view illustrating a display device according to one embodiment of the present invention. FIG. 4 is a view illustrating circuitry of the display device in FIG. 3 according to one embodiment of the present invention. FIG. 5A and FIG. 5B are views illustrating brightness change of the display device in accordance with change of gamma.

In FIG. 3, the display device of the present embodiment includes a panel 300 and a driver.

The display device of the present embodiment includes an organic electroluminescent device, a plasma display panel, a liquid crystal display, and others. Hereinafter, the organic electroluminescent device will be described as an example of the display device for convenience of the description.

The panel 100 includes a plurality of pixels E11 to E44 formed in cross areas of data lines D1 to D4 and scan lines S1 to S4.

In case that the display device is organic electroluminescent device, at least one pixel has an anode electrode layer, an organic layer and a cathode electrode layer in sequence on a substrate (not shown).

The anode electrode layer as transparent layer is made up of for example indium tin oxide.

The organic layer is made up of organic material corresponding to a certain color, and includes a hole transporting layer HTL, an emitting layer EML and an electron transporting layer ETL.

The cathode electrode layer is made up of for example aluminum Al.

When a positive voltage and a negative voltage are applied to the anode electrode layer and the cathode electrode layer, the HTL transports holes generated from the anode electrode layer into the EML, and the ETL transports electrons generated from the cathode electrode layer into the EML. The transported holes and electrons are combined in EML, thereby forms excitons. Then, the excitons are decomposed, and a light having a certain wavelength is emitted from the EML in the decomposing process.

In short, when scan signals are transmitted to the scan lines S1 to S4 and data currents are transmitted to the data lines D1 to D4, the pixels E11 to E44 emit light.

The driver includes a controller 302, a scan driving circuit 304 and a data driving circuit 306.

The controller 302 receives first display data of N (is a positive integer) bit from an outside apparatus (not shown), and controls the scan driving circuit 304 by using the received first display data.

In addition, to compensate a gamma γ, the controller 302 provides second display data of N+M) bit to the data driving circuit 306 in accordance with the first display data. Here, M is a positive integer, preferably is 1.

The scan driving circuit 304 provides the scan signals to the scan lines S1 to S4 under control of the controller 302, and so the scan lines S1 to S4 are coupled in sequence to a luminescent source, e.g. a ground.

The data driving circuit 306 provides data currents corresponding to the second display data transmitted from the controller 302 to the data lines D1 to D4. Here, the data currents mean current that gamma compensation is finished.

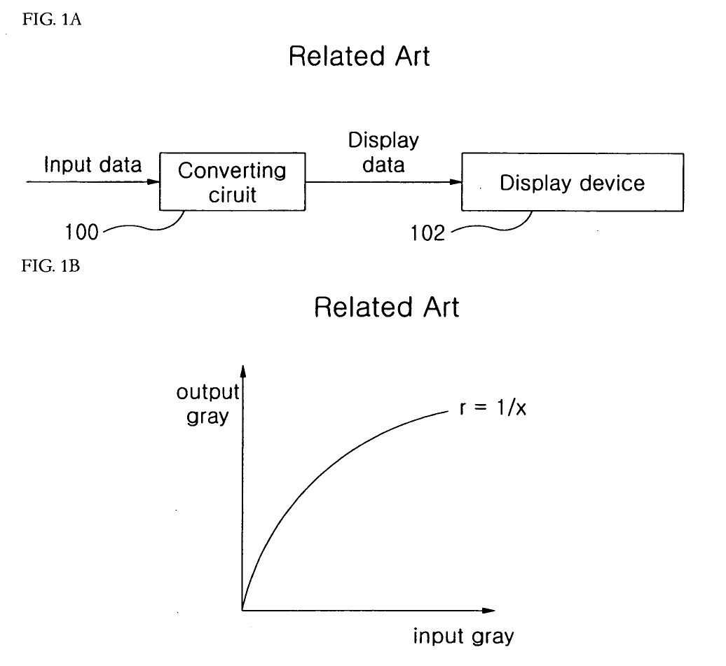

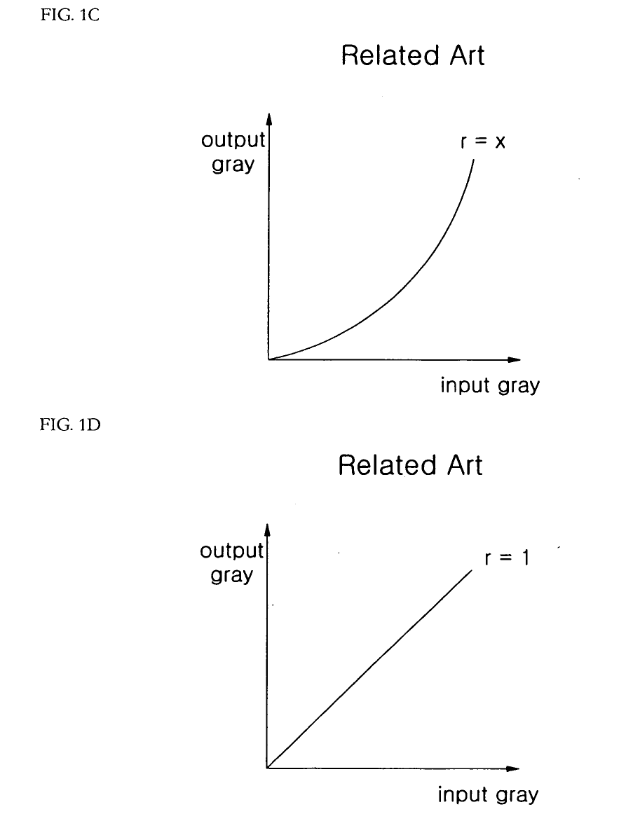

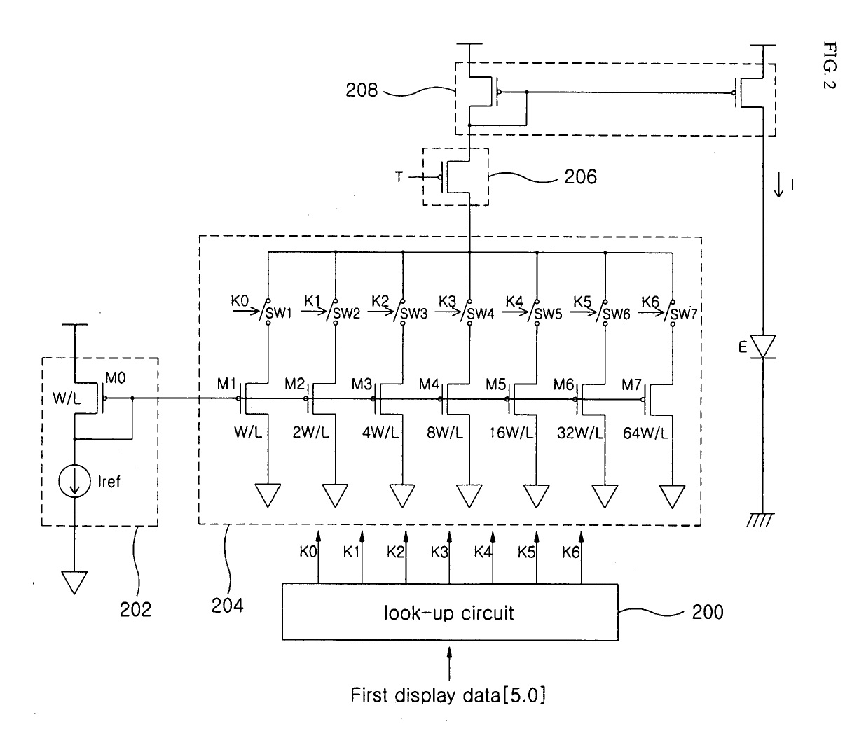

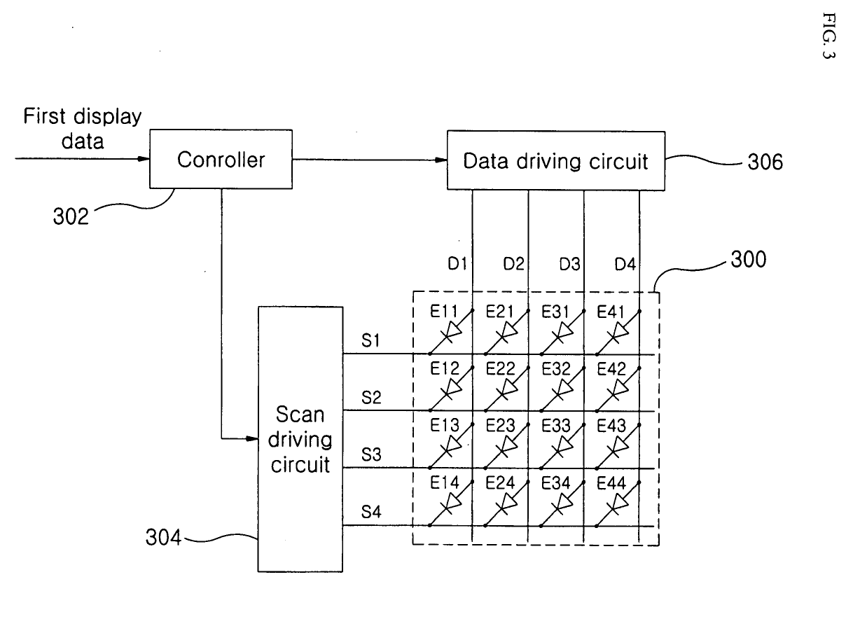

In brief, an image taken by for example a camcorder is first gamma compensated by the converting circuit 100 shown in FIG. 1A, and then is second gamma compensated by the display device of the present embodiment. That is, the image taken by the camcorder has linear characteristics by the above two gamma compensations, and the image having linear characteristics is displayed on the display device.

Hereinafter, a process of driving the display device of the present embodiment, particularly a gamma compensating process will be described in detail with reference to the accompanying drawing FIG. 4.

In FIG. 4, the controller 302 includes a look-up circuit 400 for selecting the second display data corresponding to the received first display data from a look-up table.

For instance, the look-up circuit 400 selects the second display data of 7 bits [MS, K0 to K5] corresponding to the first display data of 6 bits [5, 0] from the look-up table, and then provides the selected second display data to the data driving circuit 306. Here, MS is most significant bit or least significant bit of the second display data.

In one embodiment of the present invention, the controller 302 may not select the second data from the look-up table but generate the second display data using extra circuit.

It is assumed that the first display data has 6 bits, and the second display data has 7 bits.

The data driving circuit 306 includes a first sub-data driving circuit 402 and a second sub-data driving circuit.

The first sub-data driving circuit 402 includes a reference current circuit 404, a mode selecting circuit 406 and a current generating circuit 408.

The second sub-data driving circuit includes a time adjusting circuit 410 and a mirror circuit 412.

The reference current circuit 404 generates a reference current, and includes a plurality of current sources, preferably two current sources and MOS transistors M0 and M1 coupled respectively to the current sources.

A first current source of the current sources generates a first reference current Ir1, and a second current source thereof generates a second reference current Ir2. Here, the second reference current Ir2 is smaller than the first reference current Ir1, e.g. equals to one-tenth of the first reference current Ir1.

The MOS transistors M0 and M1 have the same magnitude, i.e. the same rate of width and length L/W

The mode selecting circuit 406 includes first switches SW1 and SW2.

The first switches SW1 and SW2 switches in accordance with the second display data provided from the look-up circuit 400. Here, one of the switches SW1 and SW2 is turned on, and the other switch maintains turn-off condition.

The current generating circuit 408 includes a plurality of second MOS transistors M2 to M7 and second switches SW3 to SW8 coupled to the second MOS transistors M2 to M7. Here, it is desirable that the second MOS transistors M2 to M7 have different magnitude one another as shown in FIG. 4.

The second switches SW3 to SW8 switches in accordance with the second display data transmitted from the look-up circuit 400.

Hereinafter, the operation of the first sub-data driving circuit 402 will be described in detail.

Firstly, in case that the switch SW1 is turned on and the switch SW2 is off, i.e. mode 0, the MOS transistor M1 coupled in series to the second current source is coupled to the MOS transistors M2 to M7 included in the current generating circuit 408. In this case, since the MOS transistor M1 and the MOS transistors M2 to M7 form mirror circuit, first current proportionate to the second reference current Ir2 is passed through the MOS transistors M2 to M7. Here, the first current is generated by using the second reference current Ir2 as a bias current. For example, current passing through the MOS transistor M2 is 1×Ir2, current passing through the MOS transistor M3 is 2×Ir2, and current passing through the MOS transistor M4 is 4×Ir2. Additionally, current passing through the MOS transistor M5 is 8×Ir2, current passing through the MOS transistor M6 is 16×Ir2, and current passing through the MOS transistor M7 is 32×Ir2.

Subsequently, when the second switch SW2 is turned on and the first switch SW1 is off, i.e. mode 1, the MOS transistor M0 coupled in sequence to the first current source is coupled to the MOS transistor M2 to M7 included in the current generating circuit 408. In this case, since the MOS transistor M0 and the MOS transistors M2 to M7 form mirror circuit, second current proportionate to the first reference current Ir1 is passed through the MOS transistors M2 to M7. Here, the second current is generated by using the first reference current Ir1 as a bias current. For example, current passing through the MOS transistor M2 is 1×Ir1, current passing through the MOS transistor M3 is 2×Ir1, and current passing through the MOS transistor M4 is 4×Ir1. Additionally, current passing through the MOS transistor M5 is 8×Ir1, current passing through the MOS transistor M6 is 16×Ir1, and current passing through the MOS transistor M7 is 32×Ir1.

In short, the first sub-data driving circuit 402 generates the first current or the second current by using the reference current Ir1 or Ir2 as a bias current. Here, the first current or second current is changed depending on the switching operation of the switches SW3 to SW8. However, the first current or second current is not changed linearly. This is because the magnitude change of the first current corresponding to the first reference current Ir1 is different from that of the second current corresponding to the second reference current Ir2. Particularly, since the second reference current Ir2 is smaller than the first reference current Ir1, the rate of magnitude change of the first current when the first reference current Ir1 is operated as bias current is higher than that of the second current when the second reference current Ir2 is operated as bias current.

For example, in FIG. 5A, the rate of magnitude change of the first current generated from the current generating circuit 408 in case of mode 0 is smaller than that of the second current in mode 1. That is, the rate of magnitude change of current in low gray scale is smaller than that of current in high gray scale. Accordingly, the rate of magnitude change, i.e. brightness change of current generated from the current generating circuit 408 and corresponding to the first display data has curve shape as shown in FIG. 5B.

In brief, the display device of the present embodiment uses gamma having rate of change of current shown in FIG. 5B so as to compensate rate of change of current in accordance with gamma characteristics of the converting circuit 100.

Hereinafter, the operation of the second sub-data driving circuit will be described in detail.

The time adjusting circuit 410 is made up of switch, e.g. MOS transistor, and is turned on during a certain time.

The mirror circuit 412 includes MOS transistors forming mirror structure. Accordingly, data current proportionate to current generated from the current generating circuit 408, e.g. first data current I1 is provided to data line, e.g. first data line D1 during the turn-on time of the time adjusting circuit 410.

In the display device of the present embodiment, the second sub-data driving circuit may be variously changed in accordance with pulse amplitude modulation or pulse width modulation. However, it will be immediately obvious to those skilled in the art that many modifications for the second sub-data driving circuit do not have any effect to the scope of the present invention.

Hereinafter, the display device of the present invention and the display device in Related Art will be compared.

The display device of the present invention unlike the display device in Related Art generates the reference currents using the current sources, and reduces the number of MOS transistors M2 to M7 included in the current generating circuit 408. Accordingly, in the display device of the present invention, the number of the current sources and the first MOS transistors M0 and M1 is increased compared with the display device in Related Art, but the number of MOS transistors M2 to M7 included in the current generating circuit 408 is reduced.

Especially, the display device of the present invention unlike the display device in Related Art need not have MOS transistor (M7 in FIG. 2) having highest size. Hence, the thickness of the display device of the present invention may be smaller than that of the display device in Related Art.

In addition, the display device of the present invention uses the second reference current Ir2 having magnitude smaller than the first reference current Ir1 in low gray scale, and thus it is possible to adjust finely brightness in low gray scale.

An embodiment may be achieved in a whole or in part by a driver comprising a controller configured to provide second display data of N(positive number)+M(positive number) bit in accordance with first display data of N bit; and a data driving circuit configured to select one of reference currents as bias current in accordance with the second display data provided to the controller, and generate current corresponding to the second display data using the selected reference current.

An embodiment may be achieved in a whole or in part by a display device comprising a plurality of pixels formed in cross areas of data lines and scan lines; and a driver configured to provide data current to at least one pixel. Here, the driver includes: a controller configured to provide second display data of N(positive number)+M(positive number) bit in accordance with first display data of N bit; a reference current circuit configured to generate reference currents; a mode selecting circuit configured to select one of the reference currents as bias current in accordance with the second display data provided from the controller; a current generating circuit configured to generate current corresponding to the second display data using the reference current selected by the mode selecting circuit; and a sub-data driving circuit configured to have mirror circuit, and provide data current proportional to the current generated from the current generating circuit using the mirror circuit.

An embodiment may be achieved in a whole or in part by a method of driving a display device having a plurality of pixels formed in cross areas of data lines and scan lines, comprising: generating a plurality of reference currents; generating data currents on the basis of one reference current selected from the reference currents; and providing the generated data currents to the pixels through the data lines. Here, rate of magnitude change of data current on the basis of first reference current of the reference currents is different from that of data current on the basis of second reference current of the reference currents.

A display device and a method of driving the same of the present invention performs gamma compensation using a plurality of current sources and a mode selecting circuit, and thus the number of MOS transistor employed in a current generating circuit is reduced. Accordingly, the thickness of the display device may be reduced.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A driver comprising:
a controller configured to provide second display data of N(positive number)+M(positive number) bit in accordance with first display data of N bit; and
a data driving circuit configured to select one of reference currents as bias current in accordance with the second display data provided to the controller, and generate current corresponding to the second display data using the selected reference current.

2. The driver of claim 1, wherein the data driving circuit includes:
a reference current circuit configured to generate the reference currents;
a mode selecting circuit configured to select one of the reference currents as bias current in accordance with the second display data provided to the controller; and
a current generating circuit configured to generate the current corresponding to the second display data using the reference current selected by the mode selecting circuit.

3. The driver of claim 2, wherein the reference current circuit includes:
a plurality of current sources; and
first MOS transistors coupled respectively to the current sources.

4. The driver of claim 3, wherein at least one of the reference currents generated from the current sources has different magnitude from the other reference current.

5. The driver of claim 3, wherein the reference current circuit includes two current sources, and the reference currents generated from the current sources have different magnitude.

6. The driver of claim 3, wherein the mode selecting circuit includes first switches coupled respectively to the first MOS transistors, and turns on some of the first switches in accordance with the second display data.

7. The driver of claim 3, wherein the current generating circuit includes:
second MOS transistors form mirror circuit with at least one of the first MOS transistors, and coupled in parallel one another; and
second switches coupled respectively to the second MOS transistors, and configured to switch in accordance with the second display data.

8. The driver of claim 7, wherein the current generating circuit includes N second MOS transistors.

9. The driver of claim 1, wherein the controller includes:
a look-up circuit configured to select the second display data corresponding to the first display data in a look-up table, and provide the selected second display data to the mode selecting circuit and the current generating circuit.

10. The driver of claim 1, wherein the M is 1.

11. A display device comprising:
a plurality of pixels formed in cross areas of data lines and scan lines; and
a driver configured to provide data current to at least one pixel,
wherein the driver includes:
a controller configured to provide second display data of N(positive number)+M(positive number) bit in accordance with first display data of N bit;
a reference current circuit configured to generate reference currents;
a mode selecting circuit configured to select one of the reference currents as bias current in accordance with the second display data provided from the controller;
a current generating circuit configured to generate current corresponding to the second display data using the reference current selected by the mode selecting circuit; and
a sub-data driving circuit configured to have mirror circuit, and provide data current proportional to the current generated from the current generating circuit using the mirror circuit.

12. The display device of claim 11, wherein the M is 1.

13. The display device of claim 11, wherein the reference current circuit includes a plurality of current sources,
wherein at least one of the reference currents generated from the current sources has different magnitude from the other reference current.

14. The display device of claim 13, wherein the mode selecting circuit has a plurality of switches coupled respectively to the current sources,
the current generating circuit is coupled to the switches, and includes MOS transistors coupled in parallel one another.

15. The display device of claim 11, wherein the controller includes a look-up circuit having a look-up table,
wherein the look-up circuit configured to select second display data corresponding to the first display data in the look-up table.

16. The display device of claim 11, wherein at least one pixel include an emitting layer made up of organic material.

17. A method of driving a display device having a plurality of pixels formed in cross areas of data lines and scan lines, comprising:
generating a plurality of reference currents;
generating data currents on the basis of one reference current selected from the reference currents; and
providing the generated data currents to the pixels through the data lines,
wherein rate of magnitude change of data current on the basis of first reference current of the reference currents is different from that of data current on the basis of second reference current of the reference currents.

18. The method of claim 17, further comprising:
generating second display data of N(positive number)+M(positive number) bit using first display data of N bit,
wherein the selected reference current is selected from the reference currents in accordance with the generated second display data, and the data currents have magnitude corresponding to the second display data.

19. The method of claim 18, wherein the M is 1.

20. The method of claim 18, wherein the second display data as data corresponding to the first display data is selected in a look-up table in accordance with the first display data.
